(19) United States
(12) Patent Application Publication
(10) Pub. No.: US 2014/0118455 A1
(43) Pub. Date: May 1, 2014

(54) OPTICAL SCANNING APPARATUS AND IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Yasushi Kuribayashi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/055,225

(22) Filed: Oct. 16, 2013

(30) Foreign Application Priority Data
Oct. 26, 2012 (JP) 2012-237288

(51) Int. Cl. B41J 2/385; G02B 26/08

(52) U.S. Cl. CPC G02B 26/125; G03G 15/043
USPC 347/118; 359/205.1

(57) ABSTRACT

An optical scanning apparatus scanning a light in a specific direction comprises a light source configured to irradiate a light; a diaphragm plate configured to comprise an opening section through which the light from the light source passes; and a holder configured to hold the diaphragm plate. The holder holds the diaphragm plate in a state of curving the diaphragm plate. The diaphragm plate in a curved state elastically deforms and comes into close contact with the holder through elastic deformation force.

### CROSS-REFERENCE TO RELATED APPLICATION

This application is based upon and claims the benefit of priority from Japanese Patent Application No. 2012-237288, filed Oct. 26, 2012, the entire contents of which are incorporated herein by reference.

### FIELD

Embodiments described herein relate to an optical scanning apparatus and an image forming apparatus comprising the optical scanning apparatus.

### BACKGROUND

In an optical scanning apparatus, a diaphragm plate having an opening section is arranged on an optical path. Herein, the diaphragm plate is fixed on a housing of the optical scanning apparatus by an adhesive.

### BRIEF DESCRIPTION OF THE DRAWINGS

FIG. 1 is a longitudinal section view of an image forming apparatus;

FIG. 2 is a plan view of an optical scanning apparatus;

FIG. 3 is a perspective view of the optical scanning apparatus;

FIG. 4 is a perspective view of one portion of the optical scanning apparatus after a diaphragm plate is mounted in a first embodiment;

FIG. 5 is a perspective view of one portion of the optical scanning apparatus before the diaphragm plate is mounted in the first embodiment;

FIG. 6 is a plan view of one portion of the optical scanning apparatus before the diaphragm plate is mounted in the first embodiment;

FIG. 7A is an A-A sectional view of FIG. 6;

FIG. 7B is a B-B sectional view of FIG. 6;

FIG. 8 is a plan view of one portion of the optical scanning apparatus after the diaphragm plate is mounted in the first embodiment;

FIG. 9A is an A-A sectional view of FIG. 8;

FIG. 9B is a B-B sectional view of FIG. 8;

FIG. 10 is a perspective view of one portion of the optical scanning apparatus after the diaphragm plate is mounted in a second embodiment;

FIG. 11 is a perspective view of one portion of the optical scanning apparatus before the diaphragm plate is mounted in the second embodiment;

FIG. 12 is a plan view of one portion of the optical scanning apparatus before the diaphragm plate is mounted in the second embodiment;

FIG. 13A is an A-A sectional view of FIG. 12;

FIG. 13B is a B-B sectional view of FIG. 12;

FIG. 14 is a plan view of one portion of the optical scanning apparatus after the diaphragm plate is mounted in the second embodiment;

FIG. 15A is an A-A sectional view of FIG. 14; and

FIG. 15B is a B-B sectional view of FIG. 14.

### DETAILED DESCRIPTION

In accordance with one embodiment, an optical scanning apparatus scanning a light in a specific direction comprises a light source configured to irradiate a light; a diaphragm plate configured to comprise an opening section through which the light from the light source passes; and a holder configured to hold the diaphragm plate. The holder holds the diaphragm plate in a state of curving the diaphragm plate. The diaphragm plate in a curved state elastically deforms and comes into close contact with the holder through elastic deformation force.

### A First Embodiment

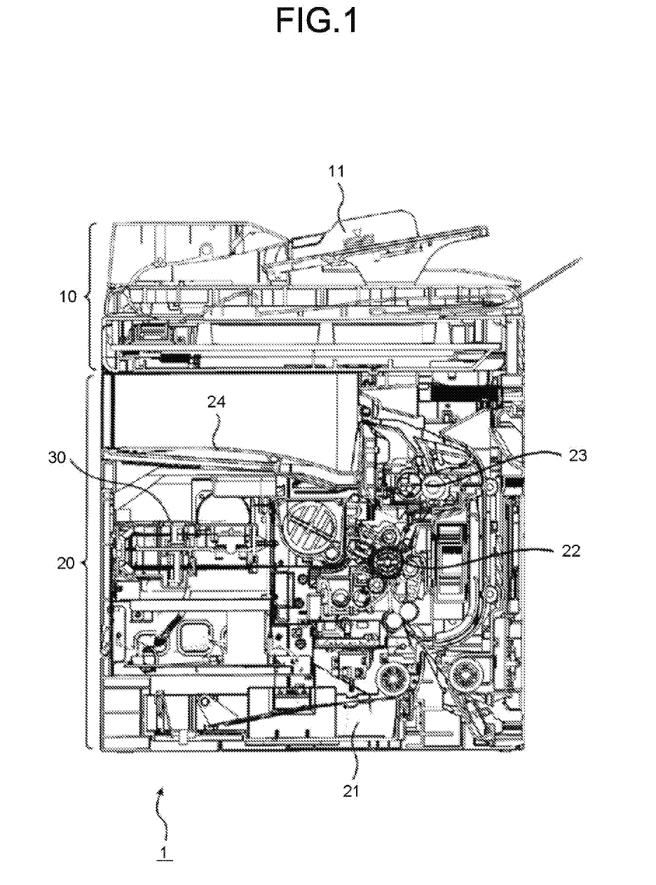

FIG. 1 is a longitudinal section view of an image forming apparatus (MFP: Multi Function Peripheral) of the present embodiment. The image forming apparatus 1 comprises an image reading section 10 and an image forming section 20. The image reading section 10 scans and reads an image of a sheet document and a book document. The image forming section 20 forms a developer image on a sheet based on the image read from a document by the image reading section 10 or image data and the like sent to the image forming apparatus 1 from an external device.

The image reading section 10 comprises an automatic document feeder (ADF) 11. The image reading section 10 reads images of a document fed by the automatic document feeder 11 and a document placed on a document table. The image forming section 20 comprises a paper feed cassette 21, a developing device 22, an optical scanning apparatus 30, a fixing device 23 and a paper discharge tray 24.

Hereinafter, operations of the image forming section 20 will be described.

The sheet stored in the paper feed cassette 21 is fed to the developing device 22 through a pickup roller and a conveyance roller. The developing device 22 forms a developer image on the sheet fed from the paper feed cassette 21. Specifically, first, a photoconductor in the developing device 22 is exposed through the light from the optical scanning apparatus 30, and thereby, an electrostatic latent image is formed on a photoconductive surface of the photoconductor.

Subsequently, the electrostatic latent image is developed by feeding the photoconductor with a developing agent. The developer image which is formed on the photoconductive surface of the photoconductor is transferred to the sheet fed from the paper feed cassette 21. The sheet to which the developer image is transferred is conveyed to the fixing device 23. The fixing device 23 fixes the developer image on the sheet by heating the sheet. The sheet passing through the fixing device 23 is conveyed to the paper discharge tray 24. The sheet conveyed from the fixing device 23 is stored in the paper discharge tray 24.

A structure of the image forming apparatus 1 shown in FIG. 1 is just an example, and it can be any structures so long as an apparatus can form the developer image on the sheet.

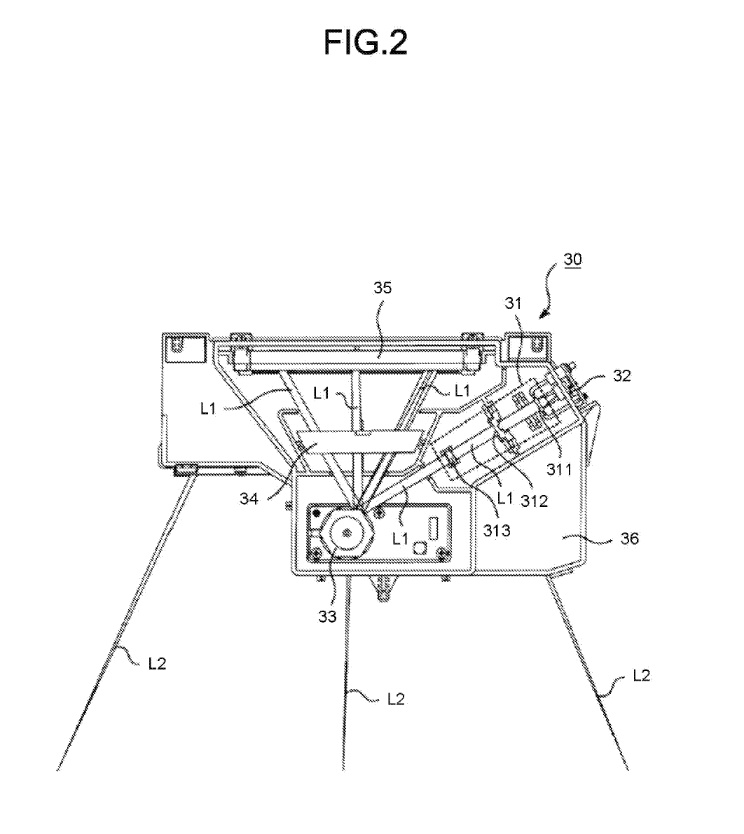

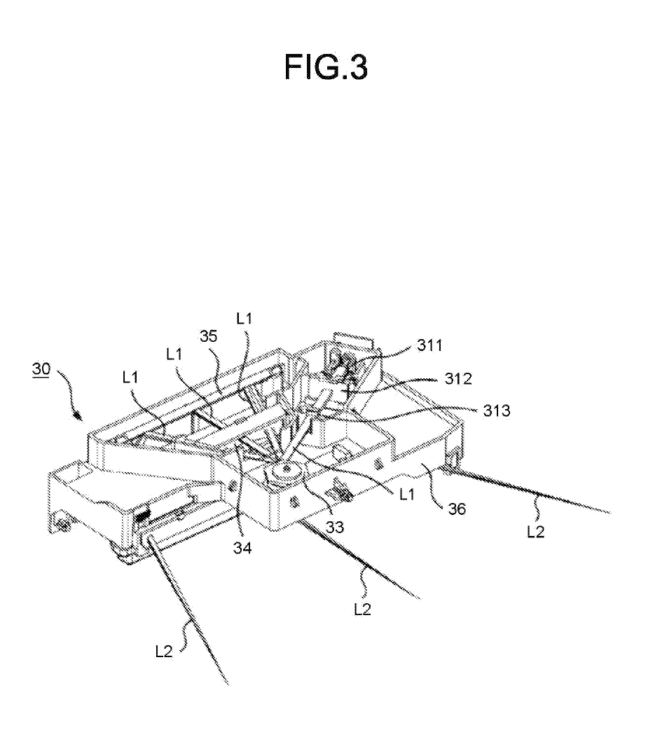

Subsequently, a structure of the optical scanning apparatus 30 will be described. FIG. 2 is a top view of the optical scanning apparatus 30, and FIG. 3 is a perspective view of the optical scanning apparatus 30.

An optical system 31 endows the light irradiated from a light source 32 with a specific characteristic. The light source 32 is fixed on a housing 36 of the optical scanning apparatus 30. The light irradiated from the light source 32 reaches a polygon mirror 33 via the optical system 31. A constitution of the optical system 31 will be described hereinafter.

The polygon mirror 33 is fixed on the housing 36 and is rotated. The polygon mirror 33 reflects the light from the optical system 31 to a scanning lens 34. The polygon mirror 33 deflects the light from the optical system 31 to a horizontal scanning direction (a left-right direction in FIG. 2) through rotation. The scanning lens 34 extends in the horizontal scanning direction, and moreover, converges a reflected light from the polygon mirror 33 in a vertical scanning direction (a direction orthogonal to the horizontal scanning direction).

The light passing through the scanning lens 34 is reflected by a mirror 35 towards the photoconductor of the developing device 22 as shown in FIG. 1. In FIG. 2 and FIG. 3, L1 represents the light reaching the mirror 35 from the light source 32. L2 represents the light reflected by the mirror 35. In FIG. 2 and FIG. 3, only one portion of the lights L1 and L2 are shown.

The optical system 31 comprises a collimator lens 311, a diaphragm plate 312 and a cylindrical lens 313. The light L1 irradiated from the light source 32 enters the collimator lens 311. As the light L1 irradiated from the light source 32 is divergent light, the collimator lens 311 converts the divergent light from the light source 32 to a parallel light.

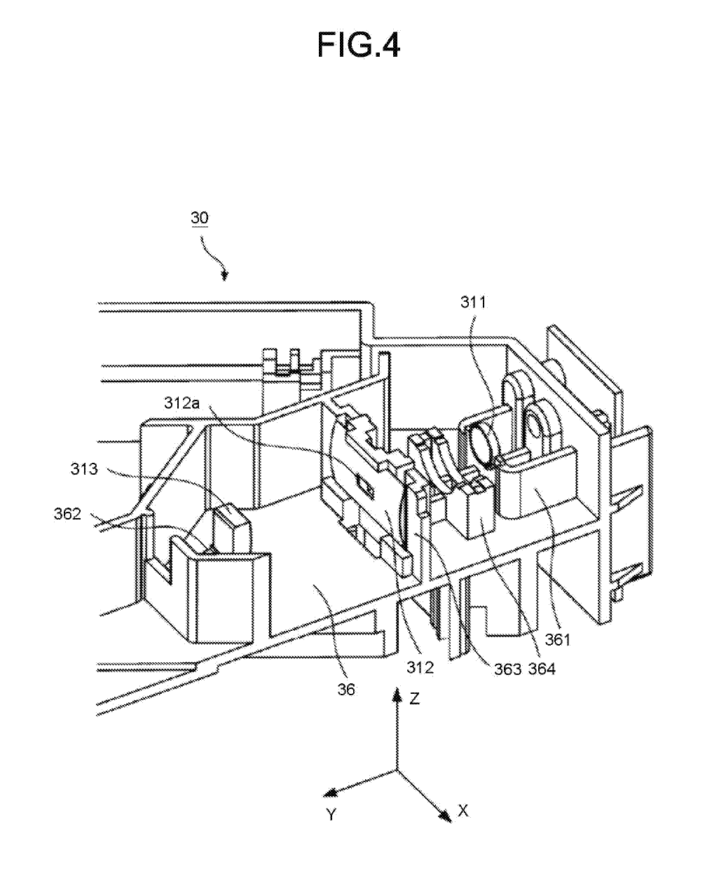

The light L1 passing through the collimator lens 311 passes through the diaphragm plate 312. As shown in FIG. 4, the diaphragm plate 312 comprises an opening section 312a through which the light from the collimator lens 311 passes. The diaphragm plate 312 is arranged such that the center of the opening section 312a is located on an optical axis. The diaphragm plate 312 shields the light which does not go towards the opening section 312a in the lights from the collimator lens 311.

The light passing through the opening section 312a of the diaphragm plate 312 enters the cylindrical lens 313. The cylindrical lens 313 converges the light from the diaphragm plate 312 in the vertical scanning direction (a direction Z in FIG. 4). In FIG. 4, an X axis, a Y axis and a Z axis are orthogonal to each other, and the Z axis is equivalent to a vertical direction of the image forming apparatus 1 (a vertical direction in FIG. 1).

In addition, the Y axis is equivalent to a direction in which the light irradiated from the light source 32 goes towards the cylindrical lens 313. In other words, the Y axis is equivalent to an optical axis direction in the optical system 31. The relation among the X axis, the Y axis and the Z axis is also the same in other accompanying drawings.

As shown in FIG. 4, the collimator lens 311, the diaphragm plate 312 and the cylindrical lens 313 are fixed on the housing 36. The housing 36 comprises a first lens holder 361. The first lens holder 361 holds the collimator lens 311 such that the center of the collimator lens 311 is located on the optical axis (design value) of the optical system 31. The housing 36 comprises a second lens holder 362. The second lens holder 362 holds the cylindrical lens 313 such that the center of the cylindrical lens 313 is located on the optical axis (design value) of the optical system 31.

The housing 36 comprises a diaphragm holder 363. The diaphragm holder 363 holds the diaphragm plate 312 such that the center of the opening section 312a is located on an optical axis (design value). As shown in FIG. 4, the diaphragm holder 363 holds the diaphragm plate 312 in a state of curving the diaphragm plate 312. The diaphragm plate 312 is formed by carrying out die cutting on a plate.

The diaphragm plate 312 is curved to incline relative to the Z axis. The diaphragm plate 312 is curved to be convex towards the cylindrical lens 313. If being curved, the diaphragm plate 312 is elastically deformed. Through the elastic deformation of the diaphragm plate 312, the diaphragm plate 312 can be brought into close contact with the diaphragm holder 363.

No specific limitation is given to the diaphragm plate 312 as long as it's made of a material which can be elastically deformed. For example, the diaphragm plate 312 can be made of a metal or a resin.

Hereinafter, a structure of the diaphragm holder 363 will be specifically described.

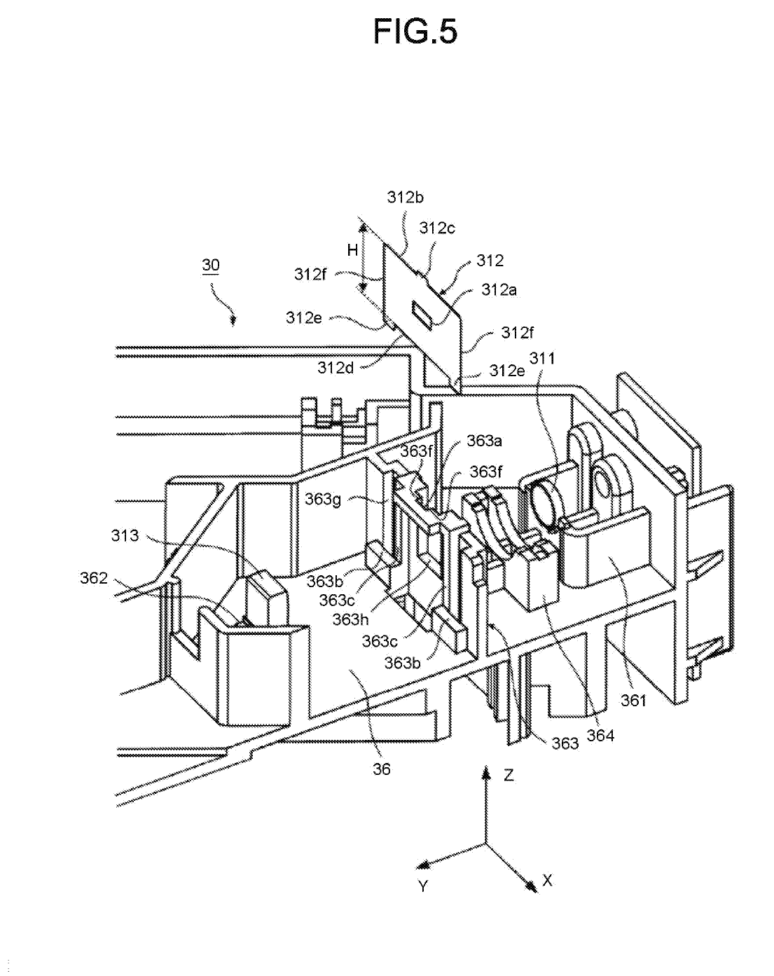

FIG. 5 illustrates a state before the diaphragm plate 312 is mounted on the diaphragm holder 363. Before being mounted on the diaphragm holder 363, the diaphragm plate 312 is in plate shape. A convex portion 312c protruding upwards is arranged at an upper end 312b of the diaphragm plate 312. The upper end 312b extends in a direction X. The convex portion 312c is located in the center of the upper end 312b in the direction X.

Convex portions 312e protruding downwards are arranged at a lower end 312d of the diaphragm plate 312. The lower end 312d extends in the direction X. Two convex portions 312e are located at two ends of the lower end 312d in the direction X. A distance between the upper end 312b and the lower end 312d in the direction Z is only H. The distance H is equivalent to a height of the diaphragm plate 312 excluding the convex portions 312c and 312e.

The diaphragm plate 312 comprises side ends 312f at two ends in the direction X. The side ends 312f extend in the direction Z. The diaphragm holder 363 comprises an opening section 363h. The opening section 363h is bigger than the opening section 312a of the diaphragm plate 312. The light from the collimator lens 311 reaches the diaphragm plate 312 via the opening section 363h of the diaphragm holder 363.

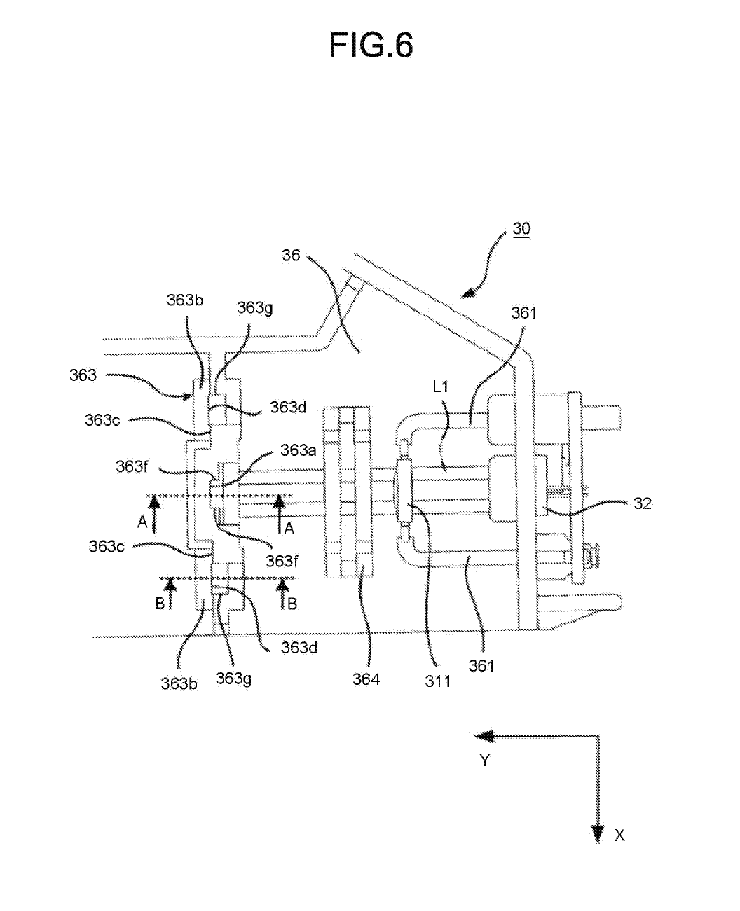

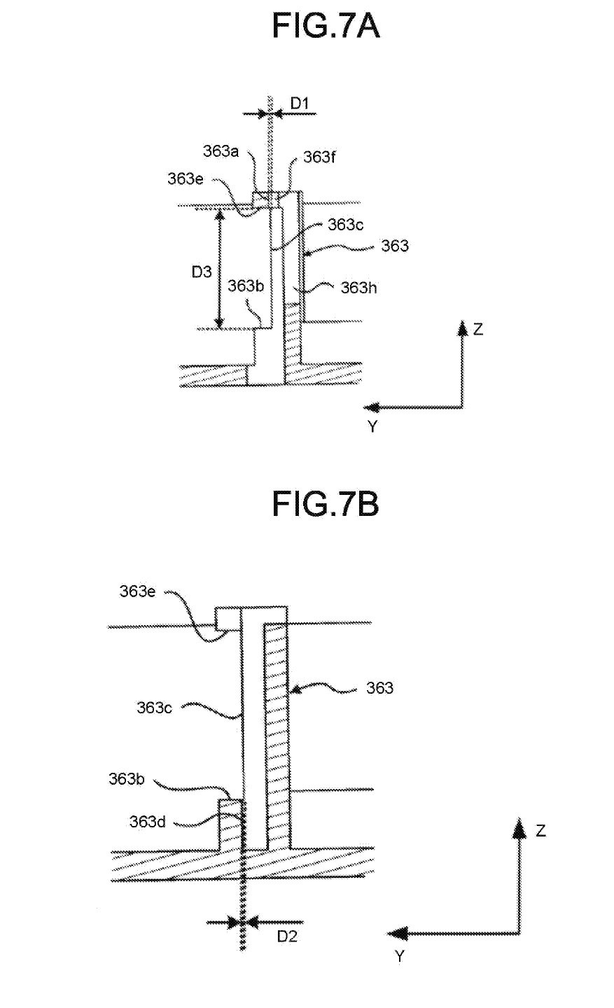

FIG. 6 is a diagram observing a structure shown in FIG. 5 from above. FIG. 7A is an A-A sectional view of FIG. 6, and FIG. 7B is a B-B sectional view of FIG. 6. In FIG. 7A and FIG. 7B, an area with a hatching represents a section of the diaphragm holder 363.

The diaphragm holder 363 comprises a first surface 363a facing to a side of the collimator lens 311 (a right side in FIG. 6). The first surface 363a is located in a plane X-Z. The diaphragm holder 363 comprises second surfaces 363b facing upwards, which are located in a plane X-Y. The second surfaces 363b are arranged at two ends of the diaphragm holder 363 in the direction X.

The diaphragm holder 363 comprises third surfaces 363c facing to a side of the cylindrical lens 313 (a left side in FIG. 6). The third surfaces 363c are located in the plane X-Z. The third surfaces 363c are arranged on two sides in the direction X relative to the first surface 363a.

As shown in FIG. 7A, the third surfaces 363c deviate from the first surface 363a towards a side of the collimator lens 311 (a right side in FIG. 7A) only at a distance of D1. In other words, the first surface 363a and the third surfaces 363c are only at the distance of D1 in a direction Y. The distance D1 is more than the thickness (the length in the direction Y) of the diaphragm plate 312.

The diaphragm holder 363 comprises fourth surfaces 363d extending downwards from the second surfaces 363b. As shown in FIG. 7B, a groove including the fourth surfaces 363d is formed in the diaphragm holder 363. The fourth surfaces 363d are located in the plane X-Z.

As shown in FIG. 7B, the fourth surfaces 363d deviate from the third surfaces 363c towards a side of the cylindrical lens 313 (a left side in FIG. 7B) only at a distance of D2. In other words, the third surfaces 363c and the fourth surfaces 363d are only at the distance of D2 in the direction Y. The distance D2 is more than the thickness (the length in the direction Y) of the diaphragm plate 312.

As shown in FIG. 7A, the diaphragm holder 363 comprises a fifth surface 363e facing downwards. The fifth surface 363e extends to a side of the cylindrical lens 313 (a left side in FIG. 7A) from a lower end of the first surface 363a. The fifth surface 363e is located in the plane X-Y. An interval D3 between the fifth surface 363e and the second surface 363b in the direction Z is less than the height H (referring to FIG. 5) of the diaphragm plate 312.

The diaphragm holder 363 comprises one pair of sixth surfaces 363f. The sixth surfaces 363f extend to a side of the collimator lens 311 (a right side in FIG. 6) from the first surface 363a, and moreover, are located in a plane Y-Z. The pair of sixth surfaces 363f faces to each other in the direction X. The diaphragm holder 363 comprises seventh surfaces 363g at two ends in the direction X. The seventh surfaces 363g are located in the plane Y-Z.

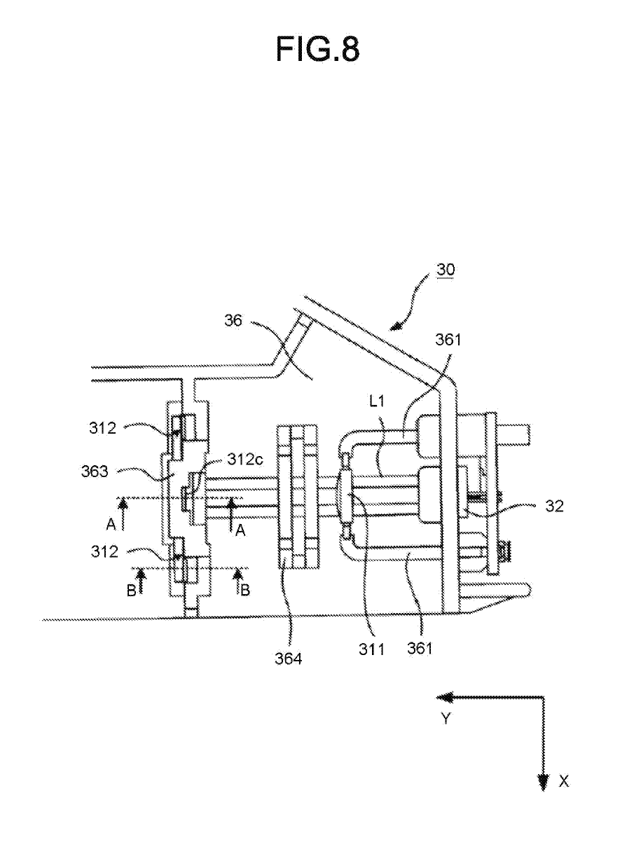

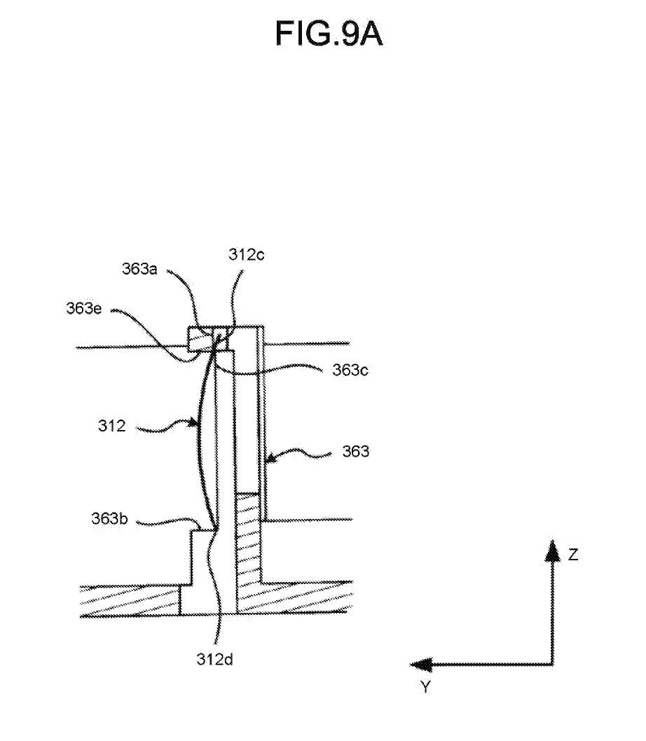

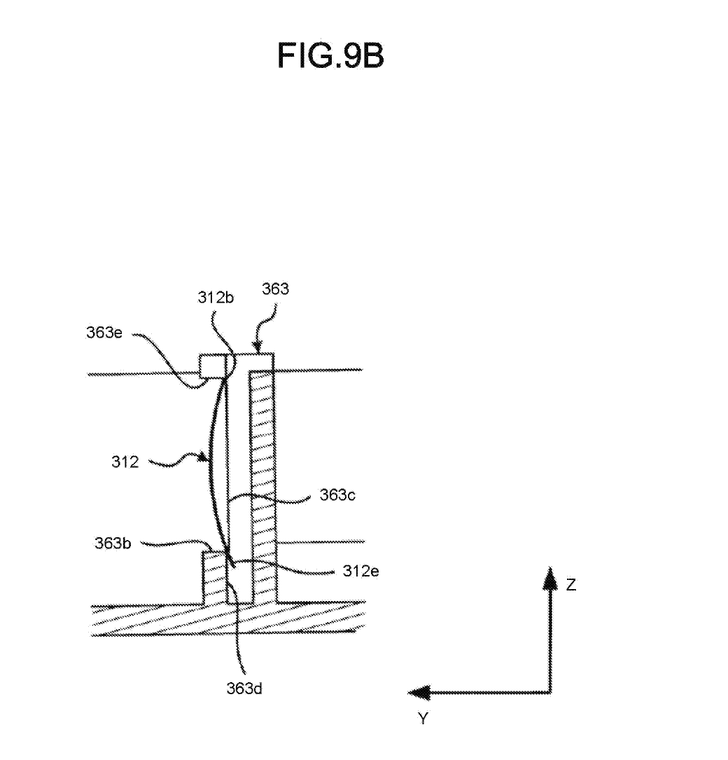

FIG. 8 is a diagram observing a structure shown in FIG. 4 from above. FIG. 9A is an A-A sectional view of FIG. 8, and FIG. 9B is a B-B sectional view of FIG. 8. In FIG. 9A and FIG. 9B, an area with a hatching represents a section of the diaphragm holder 363.

If the diaphragm plate 312 is incorporated on the diaphragm holder 363, the upper end 312b of the diaphragm plate 312 is in contact with the fifth surface 363e of the diaphragm holder 363. In addition, the lower end 312d of the diaphragm plate 312 is in contact with the second surface 363b of the diaphragm holder 363. As the interval D3 (referring to FIG. 7A) between the fifth surface 363e and the second surface 363b is less than the height H (referring to FIG. 5) of the diaphragm plate 312, as shown in FIG. 9A and FIG. 9B, the diaphragm plate 312 is curved.

As the third surfaces 363c are arranged on the diaphragm holder 363, the diaphragm plate 312 is curved to be convex towards a side of the cylindrical lens 313 (left sides in FIG. 9A and FIG. 9B). If being curved to be convex towards a side of the collimator lens 311 (right sides in FIG. 9A and FIG. 9B), the diaphragm plate 312 mutually interferes with the third surfaces 363c of the diaphragm holder 363. Therefore, the diaphragm plate 312 is curved to be convex towards a side of the cylindrical lens 313.

If being curved, the diaphragm plate 312 can generate restoring force for restoring an original state. Namely, the diaphragm plate 312 elastically deforms. Through the elastic deformation of the diaphragm plate 312, the upper end 312b of the diaphragm plate 312 displaces upwards, and thereby, the upper end 312b is brought into close contact with the fifth surface 363e of the diaphragm holder 363. Through the elastic deformation of the diaphragm plate 312, the lower end 312d of the diaphragm plate 312 displaces downwards, and thereby, the lower end 312d is brought into close contact with the second surface 363b of the diaphragm holder 363.

The diaphragm plate 312 can be fixed on the diaphragm holder 363 by being mounted on the diaphragm holder 363 in a curved state. The displacement of the upper end 312b and the lower end 312d is restricted by the diaphragm holder 363, and thereby, the diaphragm plate 312 can be positioned in the direction Z.

By being pushed in the diaphragm holder 363, the diaphragm plate 312 won't come off the diaphragm holder 363 even though the diaphragm holder 363 vibrates. When being curved to be convex towards a side of the cylindrical lens 313, the diaphragm plate 312 reflects the light from the light source 32, and can converge the light in the plane Y-Z.

By converging the light reflected by the diaphragm plate 312, the light reflected by the diaphragm plate 312 can be inhibited from diffusing around the diaphragm plate 312. Particularly, when a component influenced by the light is arranged around the diaphragm plate 312, the light reflected by the diaphragm plate 312 can be prevented from reaching the component.

As shown in FIG. 9A, the convex portion 312c of the diaphragm plate 312 is opposite to the first surface 363a of the diaphragm holder 363 in the direction Y. Specifically, the convex portion 312c is located closer to the side of the collimator lens 311 (the right side in FIG. 9A) relative to the first surface 363a. A main body (a portion except the convex portions 312c and 312e) of the diaphragm plate 312 is located closer to the side of the cylindrical lens 313 (the left side in FIG. 9A) than the third surfaces 363c of the diaphragm holder 363.

Therefore, in the direction Y, the diaphragm plate 312 is clamped by the first surface 363a and the third surfaces 363c. As shown in FIG. 7A, the first surface 363a and the third surfaces 363c are only at the distance of D1 in the direction Y, and therefore, can clamp the diaphragm plate 312.

The distance D1 is set to be a minimum distance required to incorporate the diaphragm plate 312 in the diaphragm holder 363. The diaphragm plate 312 is clamped by the first surface 363a and the third surfaces 363c, and thereby, can be positioned in the direction Y.

As shown in FIG. 9B, the convex portions 312e of the diaphragm plate 312 are opposite to the fourth surface 363d of the diaphragm holder 363 in the direction Y. In other words, the convex portions 312e are located closer to the side of the collimator lens 311 (the right side in FIG. 9B) relative to the fourth surface 363d. The main body (the portion except the convex portions 312c and 312e) of the diaphragm plate 312 is located closer to the side of the cylindrical lens 313 (the left side in FIG. 9B) than the third surfaces 363c of the diaphragm holder 363.

Therefore, in the direction Y, the diaphragm plate 312 is clamped by the fourth surface 363d and the third surfaces 363c. As shown in FIG. 7B, the third surfaces 363c and the fourth surface 363d are only at the distance of D2 in the direction Y, and therefore, can clamp the diaphragm plate 312.

The distance D2 is set to be a minimum distance required to incorporate the diaphragm plate 312 in the diaphragm holder 363. The diaphragm plate 312 is clamped by the third surfaces 363c and the fourth surface 363d, and thereby, can be positioned in the direction Y.

As described above, the diaphragm holder 363 can position the upper end 312b and the lower end 312d of the diaphragm plate 312 in the direction Y. Therefore, the whole diaphragm plate 312 can be positioned in the direction Y.

In the present embodiment, the diaphragm plate 312 is clamped by the third surfaces 363c and the fourth surface 363d while being clamped by the first surface 363a and the third surfaces 363c, and thereby, can be positioned in the direction Y. However, the diaphragm plate 312 can also be positioned in the direction Y even if being clamped by the first surface 363a and the third surfaces 363c only. In addition, the diaphragm plate 312 can also be positioned in the direction Y even if being clamped by the third surfaces 363c and the fourth surface 363d only.

The pair of sixth surfaces 363f is contacted with the convex portion 312c, thereby, the convex portion 312c can be prevented from deviating in the direction X. In addition, the pair of seventh surfaces 363g is contacted with the side ends 312f of the diaphragm plate 312, thereby, the diaphragm plate 312 can be prevented from deviating in the direction X. Thereby, in the direction X, the diaphragm plate 312 can be positioned.

In the present embodiment, the diaphragm plate 312 is positioned in the direction X by the sixth surfaces 363f and the seventh surfaces 363g, however, the diaphragm plate 312 can be also positioned in the direction X even by one pair of the sixth surfaces 363f and the seventh surfaces 363g only.

As described above, the diaphragm holder 363 can position the diaphragm plate 312 in the direction X, the direction Y and the direction Z by the surfaces 363a to 363g. Namely, the diaphragm plate 312 can be fixed on the diaphragm holder 363. In accordance with the present embodiment, the diaphragm plate 312 can be also fixed on the diaphragm holder 363 even though an adhesive is not used.

As described above, in the present embodiment, the diaphragm plate 312 is positioned in the direction Z, the direction Y and the direction Z by using the surfaces 363a to 363g, and moreover, the diaphragm plate 312 is incorporated in the diaphragm holder 363 in a curved state, which is quite easy. If being curved, the diaphragm plate 312 can be elastically deformed, and moreover, can be pushed in the diaphragm holder 363. Thereby, the diaphragm plate 312 can be fixed on the diaphragm holder 363.

In the present embodiment, the diaphragm plate 312 is curved to incline relative to the Z axis, however, it is not limited to this, the diaphragm plate 312 can also be curved to incline relative to the X axis. When the diaphragm plate 312 is curved to incline relative to the X axis, in the structure of the diaphragm holder 363 shown in FIG. 4, the structure of the diaphragm holder 363 only needs to be changed properly to make the Z axis as the X axis.

### A Second Embodiment

Hereinafter, the second embodiment will be described. In the second embodiment, the structure of the diaphragm holder is different compared with that in the first embodiment. Hereinafter, the structure of the diaphragm holder in the present embodiment will be specifically described.

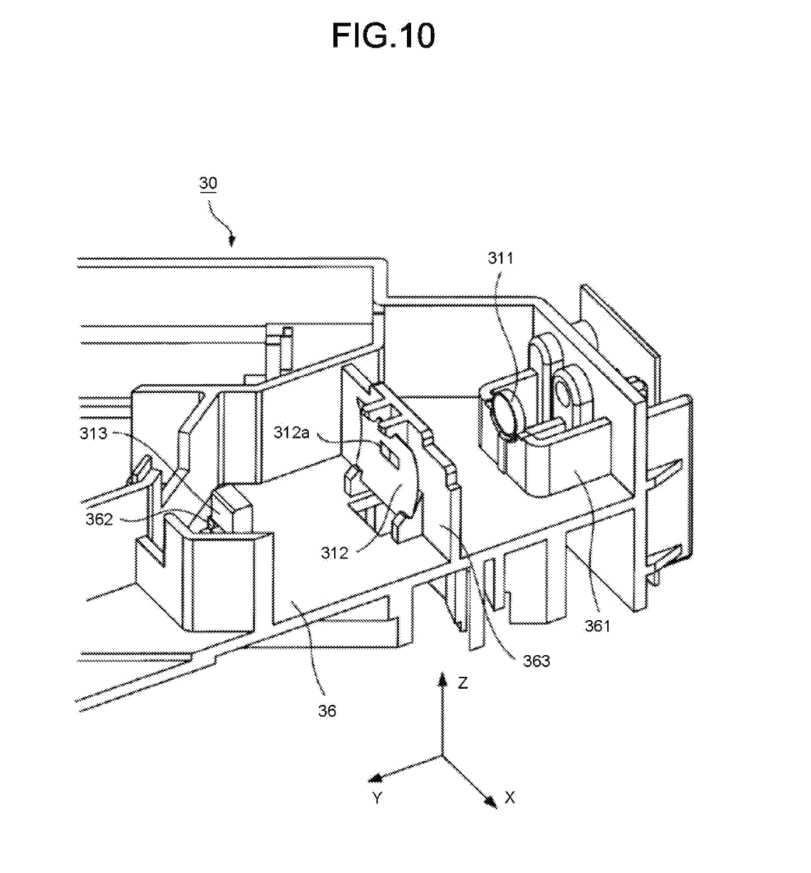

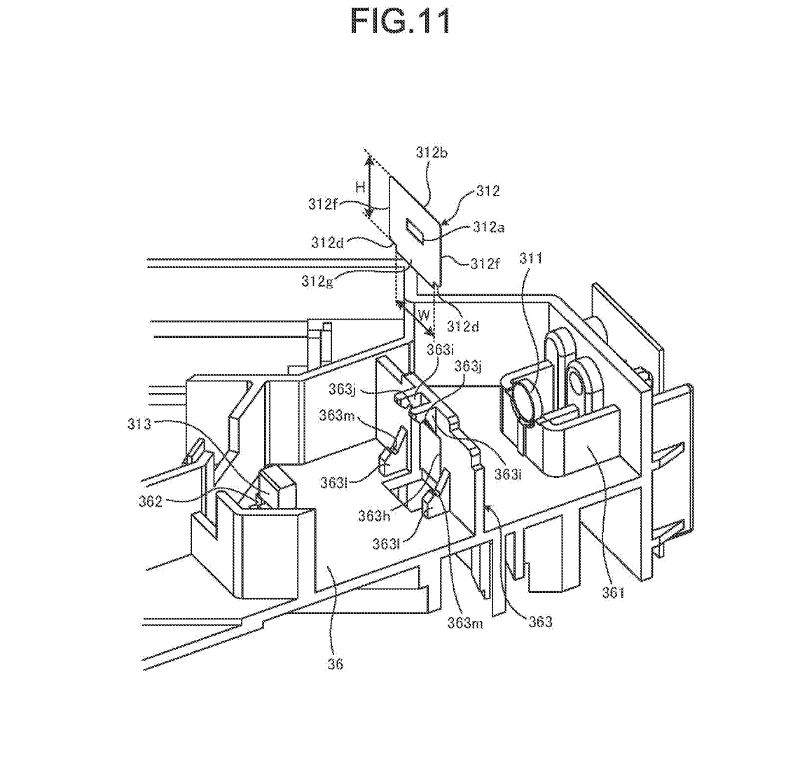

FIG. 10 illustrates a state after the diaphragm plate 312 is mounted on the diaphragm holder 363, and FIG. 11 illustrates a state after the diaphragm plate 312 is demounted from the diaphragm holder 363. As shown in FIG. 10, the diaphragm holder 363 holds the diaphragm plate 312 in a state of curving the diaphragm plate 312. The diaphragm plate 312 is curved to be convex towards the side of the collimator lens 311.

The diaphragm plate 312 comprises the upper end 312b, one pair of side ends 312f and the lower end 312d. A convex portion 312g protrudes downwards from the lower end 312d. W shown in FIG. 11 is the length of the convex portion 312g in the direction X.

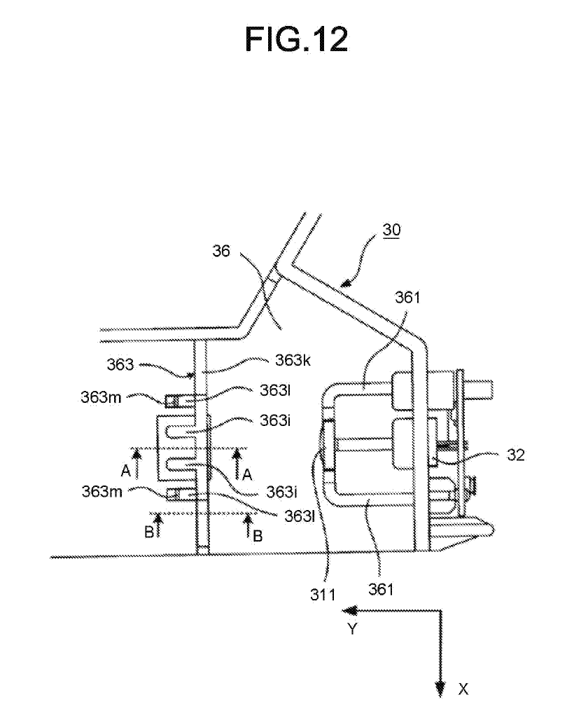

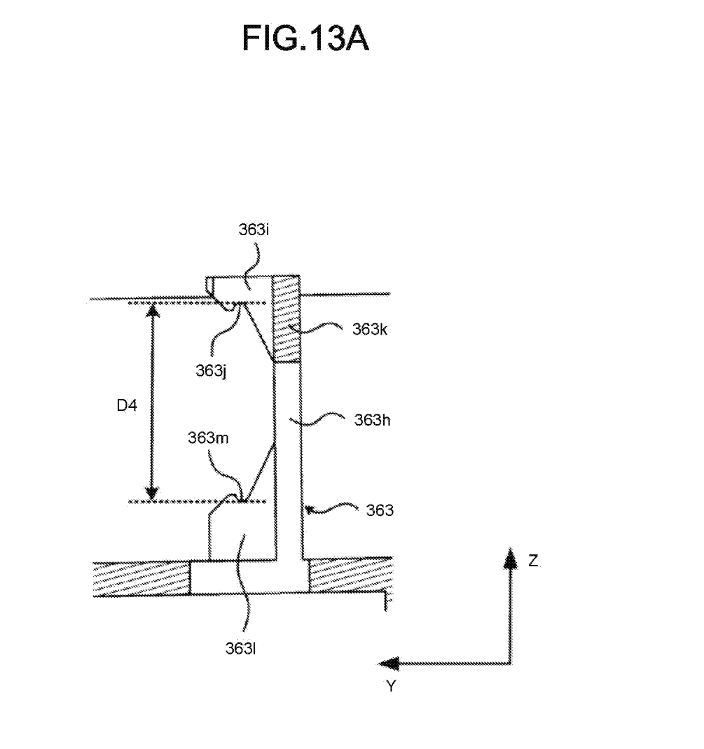

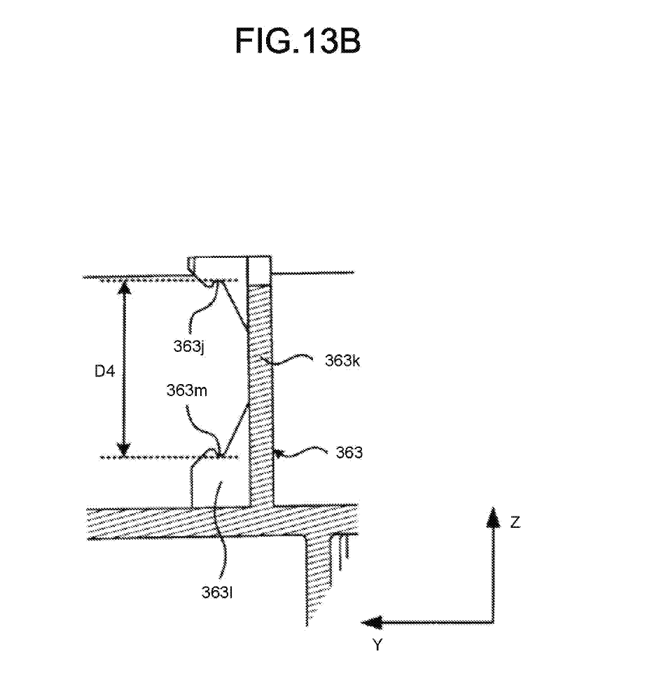

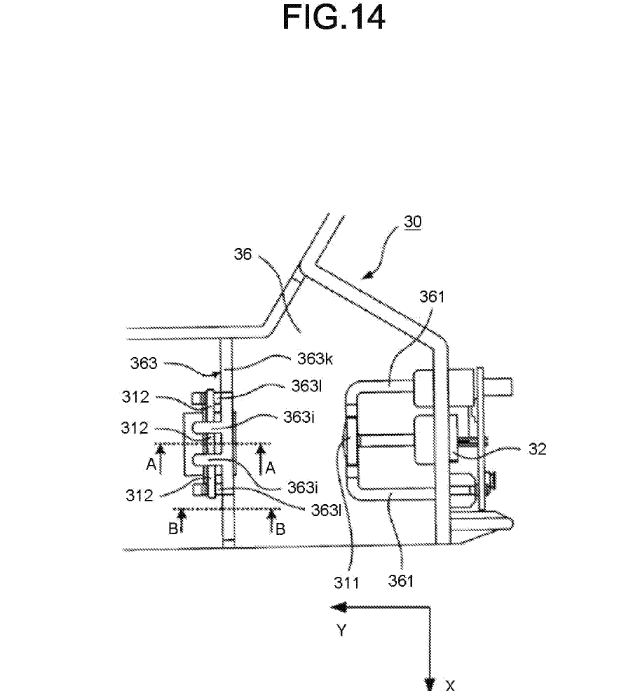

FIG. 12 is a diagram observing a structure shown in FIG. 11 from above. FIG. 13A is an A-A sectional view of FIG. 12, and FIG. 13B is a B-B sectional view of FIG. 12. In FIG. 13A and FIG. 13B, an area with a hatching represents a section of the diaphragm holder 363.

The diaphragm holder 363 comprises one pair of arms 363i at an upper end. Each arm 363i comprises a concave section 363j recessed upwards. The concave sections 363j are constituted with curved surfaces. The concave sections 363j are arranged at the side of the cylindrical lens 313 relative to a holder main body 363k of the diaphragm holder 363, and are at a distance from the holder main body 363k in the direction Y.

The diaphragm holder 363 comprises one pair of arms 3631 at a lower end. Each arm 3631 comprises a concave section 363m recessed downwards. The concave sections 363m are constituted with curved surfaces. The concave sections 363m are arranged at the side of the cylindrical lens 313 relative to the holder main body 363k of the diaphragm holder 363, and are at a distance from the holder main body 363k in the direction Y.

A distance D4 shown in FIG. 13A is a distance between the bottom surface of the concave section 363j and the bottom surface of the concave section 363m. In other words, a maximum interval in intervals between the concave section 363j and the concave section 363m is the distance D4. The distance D4 is less than the height H (referring to FIG. 11) of the diaphragm plate 312.

An interval (a length in the direction X) between the pair of arms 363i is less than an interval (a length in the direction X) of the pair of arms 3631. The interval between the pair of arms 3631 is more than the length W of the diaphragm plate 312. Thereby, the convex portion 312g of the diaphragm plate 312 can be inserted between the pair of arms 3631.

Herein, it's preferred that the interval between the pair of arms 3631 is an interval with which each arm 3631 can be in contact with the convex portion 312g. The diaphragm plate 312 can be positioned in the direction X by being brought into contact with the pair of arms 3631.

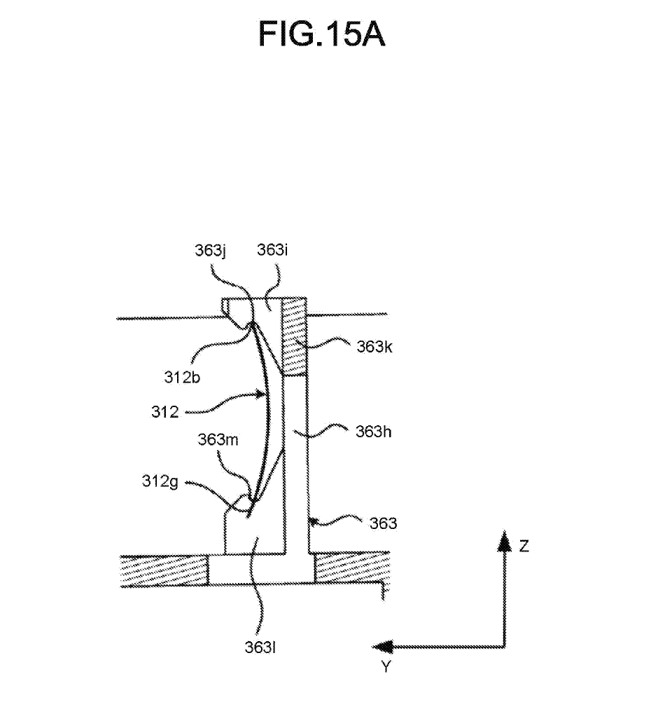

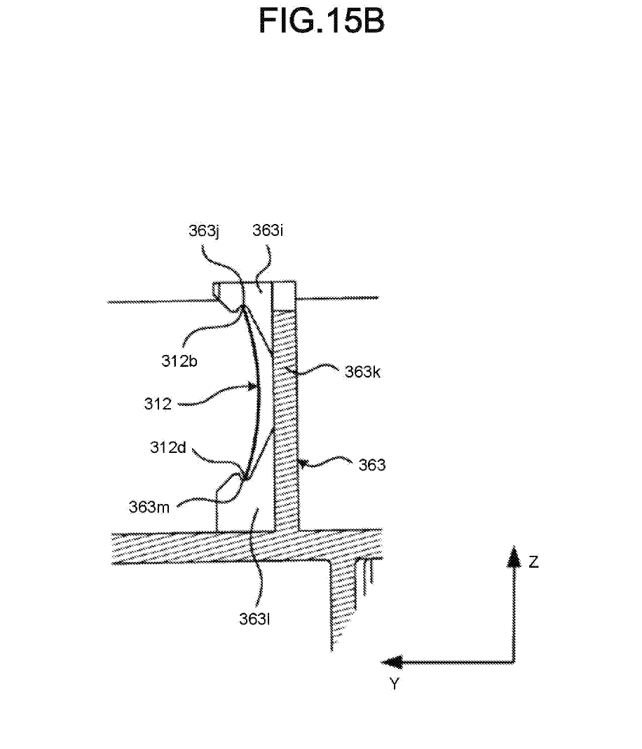

FIG. 14 is a diagram observing a structure shown in FIG. 10 from above. FIG. 15A is an A-A sectional view of FIG. 14, and FIG. 15B is a B-B sectional view of FIG. 14. In FIG. 15A and FIG. 15B, an area with a hatching represents a section of the diaphragm holder 363.

If the diaphragm plate 312 is incorporated into the diaphragm holder 363, the upper end 312b of the diaphragm plate 312 is in contact with the concave section 363j of the diaphragm holder 363. In addition, the lower end 312d of the diaphragm plate 312 is in contact with the concave section 363m of the diaphragm holder 363. As the interval D4 (referring to FIG. 13A and FIG. 13B) between the concave section 363j and the concave section 363m is less than the height H (referring to FIG. 11) of the diaphragm plate 312, as shown in FIG. 15A and FIG. 15B, the diaphragm plate 312 is curved.

As the concave sections 363j and 363m are arranged at a distance from the holder main body 363k in the direction Y, the diaphragm plate 312 is curved to be convex towards the side of the collimator lens 311 (right sides in FIG. 15A and FIG. 15B).

In the present embodiment, by being pressed towards the holder main body 363k, the diaphragm plate 312 can be mounted on the diaphragm holder 363. When being pressed towards the holder main body 363k, the diaphragm plate 312 is curved to be convex towards the side of the collimator lens 311. Therefore, the diaphragm plate 312 can be easily mounted on the diaphragm holder 363.

If being curved, the diaphragm plate 312 can generate the restoring force for restoring the original state. Namely, the diaphragm plate 312 is elastically deformed. Through the elastic deformation of the diaphragm plate 312, the upper end 312b of the diaphragm plate 312 displaces upwards, and thereby, the upper end 312b is brought into close contact with the concave section 363j of the diaphragm holder 363. Through the elastic deformation of the diaphragm plate 312, the lower end 312d of the diaphragm plate 312 displaces downwards, and thereby, the lower end 312d is brought into close contact with the concave section 363m of the diaphragm holder 363.

The diaphragm plate 312 can be fixed on the diaphragm holder 363 by being mounted on the diaphragm holder 363 in a curved state. The displacement of the upper end 312b and the lower end 312d is restricted by the diaphragm holder 363, and thereby, the diaphragm plate 312 can be positioned in the direction Z.

By being pushed in the diaphragm holder 363, the diaphragm plate 312 won't come off the diaphragm holder 363 even though the diaphragm holder 363 vibrates. When being curved to be convex towards the side of the collimator lens 311, the diaphragm plate 312 reflects the light from the light source 32, and moreover, can diffuse the light in the plane Y-Z. By diffusing the light reflected by the diaphragm plate 312, the light which does not pass through the opening section 312a of the diaphragm plate 312 can be guided to a direction leaving the optical path of the optical system 31.

In the present embodiment, the diaphragm plate 312 is positioned in the direction X by contacting the convex portion 312g with the pair of arms 3631, but it may also be set that the convex portion 312g is not in contact with the arms 3631. The diaphragm plate 312 can be fixed on the diaphragm holder 363 only by being curved.

In the present embodiment, the diaphragm plate 312 is curved to incline relative to the Z axis, however, it is not limited to this, and the diaphragm plate 312 can also be curved to incline relative to the X axis. When the diaphragm plate 312 is inclined relative to the X axis, in the structure of the diaphragm holder 363 shown in FIG. 10, the structure of the diaphragm holder 363 only needs to be changed properly to make the Z axis as the X axis.

In accordance with the embodiment described above, the diaphragm plate 312 can also be fixed on the diaphragm holder 363 only by being curved, even though an adhesive is not used. Since the diaphragm plate 312 is brought into close contact with the diaphragm holder 363 through the elastic deformation, the diaphragm plate 312 can be inhibited from deviating relative to the diaphragm holder 363.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An optical scanning apparatus scanning a light in a specific direction, comprising:
a light source configured to irradiate a light;
a diaphragm plate configured to comprise an opening section through which the light from the light source passes; and
a holder configured to hold the diaphragm plate in a state of curving the diaphragm plate, and moreover, to be in close contact with the diaphragm plate through elastic deformation force of the diaphragm.

2. The optical scanning apparatus according to claim 1, wherein
the diaphragm plate is curved to be convex towards a side of the light source.

3. The optical scanning apparatus according to claim 1, wherein
the holder comprises one pair of planes for clamping the diaphragm plate in an optical axis direction.

4. The optical scanning apparatus according to claim 1, wherein
the holder comprises one pair of planes for clamping the diaphragm plate in a direction orthogonal to the optical axis direction, which is, moreover, a direction in which the diaphragm plate is not curved.

5. An image forming apparatus, comprising:
an optical scanning apparatus according to claim 1;
a developing device configured to accept a light from the optical scanning apparatus, form an electrostatic latent image, and transfer a developer image corresponding to the electrostatic latent image on a sheet; and
a fixing device configured to heat the sheet on which the developer is transferred and fix the developer on the sheet.
